(19) United States
(12) Patent Application Publication
(10) Pub. No.: US 2024/0309133 A1
(43) Pub. Date: Sep. 19, 2024

(54) PROPYLENE TERPOLYMER AND HEAT SEAL FILMS MADE THEREFROM

(71) Applicant: W.R. Grace & Co.-Conn., Columbia, MD (US)

(72) Inventors: Zhiru MA, Ellicott City, MD (US); Jose Manuel REGO, Fulton, MD (US); Jonathan REEDS, Columbia, MD (US); Ping CAI, Lake Jackson, TX (US)

(73) Assignee: W.R. Grace & Co.-Conn., Columbia, MD (US)

(21) Appl. No.: 18/576,017

(22) PCT Filed: Jun. 30, 2022
(86) PCT No.: PCT/US2022/035826

§ 371 Date: Jan. 2, 2024

Related U.S. Application Data
(60) Provisional application No. 63/218,156, filed on Jul. 2, 2021.

(51) Int. Cl. C08F 210/06; B32B 27/08; B32B 27/32; C08J 5/18

(52) U.S. Cl. CPC C08F 210/06; B32B 27/08; B32B 27/32; C08J 5/18; B32B 2250/24; B32B 2307/308; B32B 2439/46; B32B 2439/70; C08J 2323/14

(57) ABSTRACT

A propylene terpolymer is constructed that is particularly well suited for use in heat seal applications. The propylene terpolymer, for instance, can be used to form a heat seal layer on a multilayer film. The heat seal layer can be used to bond two opposing layers of film together for forming packages and other articles. The propylene terpolymer is formed with an increased random ethylene distribution that results in reduced polymer crystallinity, reduced melting temperature, and lower heat seal temperature.

### CROSS-REFERENCE TO RELATED APPLICATIONS

This application claims the benefit of priority to U.S. Provisional Patent Application No. 63/218,156, filed on Jul. 2, 2021, the contents of which are incorporated herein by reference in their entirety.

### BACKGROUND

Polyolefin polymers are used in numerous and diverse applications and fields. Polyolefin polymers, for instance, are thermoplastic polymers that can be easily processed. The polyolefin polymers can also be recycled and reused. Polyolefin polymers are formed from hydrocarbons, such as propylene and alpha-olefins, which are obtained from petrochemicals and are abundantly available.

In one application, polyolefin polymers are formulated and designed for use in producing heat seal films and packaging. Heat seal films for use in packaging typically contain a plurality of polymer layers. At least one surface layer is referred to as a heat seal layer that is formulated to have lower melting temperatures for heat sealing or thermally bonding to an adjacent layer when sealing a package. In the past, polypropylene terpolymers have been used to construct the heat seal layer. The polypropylene terpolymers are typically produced from a combination of monomers including propylene, ethylene, and 1-butene or another higher alpha-olefin monomer. Incorporation of the ethylene monomer can lower the melting temperature of the resulting polymer. Incorporating a third monomer, such as 1-butene, can improve the overall properties of the polymer and the heat seal layer made from the polymer. For example, butene may lower the heat seal initiation temperature at higher melting temperatures.

Polypropylene terpolymers, for instance, have demonstrated desirable physical properties in packaging applications with respect to tensile strength, tear resistance, scratch resistance, and low turbidity. Various different heat sealable films, for instance, are disclosed in U.S. Pat. Nos. 4,256,784, 6,365,682, U.S. Patent Publication No. 2006/0029824, and U.S. Patent Publication No. 2004/0081842, which are all incorporated herein by reference.

Although various heat sealable films have been produced in the past, further improvements are still needed. In particular, a need remains for a polymer formulated for heat seal applications that exhibits a lower melting temperature and a reduced heat seal initiation temperature, without increasing comonomer content or otherwise degrading other properties of the polymer or film layers made from the polymer. Lowering the heat seal initiation temperature, for instance, can significantly decrease sealing time in film packaging applications that can translate into a reduction in cycle time and an increase in productivity. A need also exists for a polymer formulated for heat seal applications that has lower ethylene content and that can be produced without reactor fouling issues.

### SUMMARY

In general, the present disclosure is directed to a propylene terpolymer well suited for use as a heat seal layer in packaging film. The propylene terpolymer of the present disclosure, in one embodiment, contains propylene as a primary monomer, has an ethylene content of from about 1% to about 5% by weight, and has a butene content of from about 1% to less than 8% by weight. The propylene terpolymer has a melt flow rate of from about 1 g/10 min to about 30 g/10 min, has a melting temperature of less than 140° C., and has a sequence length distribution of ethylene defined as follows:

$$nE < 0.0 \; 353 Et + 1.08$$

wherein Et is the ethylene content by weight. Of particular advantage, the propylene terpolymer of the present disclosure can be formulated so as to be phthalate free.

In one aspect, the butene content of the propylene terpolymer is from about 3% to about 6.9% by weight, such as from about 5% to about 6.9% by weight. In one aspect, the ethylene content of the propylene terpolymer can be from about 1.5% to about 3.5% by weight. The propylene terpolymer can be Ziegler-Natta catalyzed without using a phthalate internal electron donor. The propylene content of the propylene terpolymer is generally greater than about 87% by weight, such as greater than about 90% by weight, such as greater than about 92% by weight, such as greater than about 94% by weight, and generally less than about 98% by weight.

The propylene terpolymer of the present disclosure as formulated above can have a heat seal initiation temperature of less than about 115° C., such as less than about 110° C. The propylene terpolymer can have a melting temperature, in one aspect, of from about 110°° C. to about 129° C. The melt flow rate can be from about 2 g/10 min to about 10 g/10 min. In one aspect, the terpolymer can have a sequence length distribution of ethylene of from about 1.0 to about 1.2. Optionally, the propylene terpolymer can be a visbroken propylene terpolymer.

The present disclosure is also directed to a polymer composition containing the propylene terpolymer as described above. The propylene terpolymer can be present in the polymer composition in an amount greater than about 70% by weight, such as in an amount greater than about 80% by weight, such as in an amount greater than about 90% by weight, such as in an amount greater than about 95% by weight. The polymer composition can also contain various other additives including one or more antioxidants, one or more acid scavengers, one or more UV stabilizers, one or more heat stabilizers, slip agents, anti-block agents or the like.

The present disclosure is also directed to a polymer film layer containing the propylene terpolymer as described above. The polymer film layer can be formed from the polymer composition.

In still another aspect, the present disclosure is directed to a multilayer film structure. The multilayer film structure includes a base layer comprising a thermoplastic polymer and a heat seal layer comprising a propylene terpolymer. The propylene terpolymer can have the characteristics as described above. In one aspect, the multilayer film structure can comprise a packaging film. The film structure can be formed by being coextruded. If desired, the film structure can also be unidirectionally oriented or biaxially oriented.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures.

FIG. 1 is a cross-sectional view of one embodiment of a multilayer film made in accordance with the present disclosure.

FIG. 2 is a cross-sectional view of an alternative embodiment of a multilayer film made in accordance with the present disclosure.

FIG. 3 is a perspective view of a heat seal package that may be made in accordance with the present disclosure.

FIG. 4 is a graphical representation of some of the results presented in the example below.

Repeat use of reference characters in the present specification and drawings is intended to represent the same or analogous features or elements of the present invention.

### DEFINITIONS AND TESTING PROCEDURES

The term “propylene terpolymer”, as used herein, is a terpolymer containing a majority weight percent propylene monomer combined with at least two comonomers. such as ethylene and another alpha-olefin monomer, such as 1-butene. The propylene terpolymer can have individual repeating units of the other comonomers present in a random or statistical distribution in the polymer chain.

Melt flow rate (MFR), as used herein, is measured in accordance with the ASTM D1238 test method at 230° C. with a 2.16 kg weight for propylene-based polymers.

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-06 using a 60 minute precipitation time and is also referred to herein as the “wet method”. XS can also be measured according to the Viscotek method, as follows: 0.4 g of polymer is dissolved in 20 ml of xylenes with stirring at 130° C. for 60 minutes. The solution is then cooled to 25° C. and after 60 minutes the insoluble polymer fraction is filtered off The resulting filtrate is analyzed by Flow Injection Polymer Analysis using a Viscotek ViscoGEL H-100-3078 column with THF mobile phase flowing at 1.0 ml/min The column is coupled to a Viscotek Model 302 Triple Detector Array, with light scattering, viscometer and refractometer detectors operating at 45° C. Instrument calibration is maintained with Viscotek PolyCAL™ polystyrene standards. A polypropylene (PP) homopolymer, such as biaxially oriented polypropylene (BOPP) grade L5D98 available from various commercial sources, is used as a reference material to ensure that the Viscotek instrument and sample preparation procedures provide consistent results by using L5D98 as a control to check method performance The value for LSD98 is initially derived from testing using the ASTM method identified above.

The ASTM D5492-06 method mentioned above may be adapted to determine the xylene soluble portion. In general, the procedure consists of weighing 2 g of sample and dissolving the sample in 200 ml o-xylene in a 400 ml flask with 24/40 joint. The flask is connected to a water cooled condenser and the contents are stirred and heated to reflux under nitrogen (N₂), and then maintained at reflux for an additional 30 minutes. The solution is then cooled in a temperature controlled water bath at 25° C. for 60 minutes to allow the crystallization of the xylene insoluble fraction Once the solution is cooled and the insoluble fraction precipitates from the solution, the separation of the xylene soluble portion (XS) from the xylene insoluble portion (XI) is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt % )=[(m₃−m₂)*2/m₁]*100, where m₁ is the original weight of the sample used, m₂ is the weight of empty aluminum pan, and m₃ is the weight of the pan and residue (the asterisk, *, here and elsewhere in the disclosure indicates that the identified terms or values are multiplied)

The sequence distribution of monomers in the polymer may be determined by ¹³C-NMR, which can also locate butene residues in relation to the neighboring propylene residues. ¹³C NMR can be used to measure ethylene content, butene content, triad distribution, and triad tacticity, and is performed as follows. The samples were prepared by adding approximately 2.7 g of a 50/50 mixture of tetrachloroethane-d2/orthodichlorobenzene containing 0 025 M Cr(AcAc)3 to 0.20 g sample in a Norell 1001-7 10 mm NMR tube. The samples are dissolved and homogenized by heating the tube and its contents to 150° C. using a beating block Each sample is visually inspected to ensure homogeneity. The data was collected using a Bruker 400 MHz spectrometer equipped with a Bruker Dual DUL high-temperature CryoProbe. The data are acquired using 512 transients per data file, a 6 sec pulse repetition delay, 90 degree Flip angles, and inverse gated decoupling with a sample temperature of 120° C. All measurements are made on non-spinning samples in locked mode Samples are allowed to thermally equilibrate for 10 minutes prior to data acquisition. Percent mm tacticity and weight % butene are calculated according to methods commonly used in the art, which is briefly summarized as follows.

The sequence length distribution is defined by the following equation:

$$nE < 0.0 \; 353 Et + 1.08$$

wherein Et is the ethylene content by weight and the sequence length is defined by the following equation:

$$n \text{?} = 2 \text{?} \begin{matrix}( EE + \frac{PE}{2} + \frac{BE}{2} ) \\ ( PE + BE )\end{matrix}$$

$$\text{?} \text{indicates text missing or illegible when filed}$$

Sequence length is measured by ¹³C NMR spectroscopy. Peak assignments, comonomer content, and monomer sequence lengths (nE) are calculated according to the methods described in Zhang et al. Polymer Journal, Vol 35, No. 7, pp 551-559 (2003).

For convenience, butene content is also measured using a Fourier Transform Infrared method (FTIR) which is correlated to butene values determined using ¹³C NMR, noted above, as the primary method. The relationship and agreement between measurements conducted using the two methods is described in, e.g., J. R. Paxson, J. C. Randall, “Quantitative Measurement of Ethylene Incorporation into Propylene Copolymers by Carbon-13 Nuclear Magnetic Resonance and Infrared Spectroscopy”, Analytical Chemistry, Vol. 50, No. 13, November 1978, 1777-1780.

Mw/Mn (also referred to as “MWD”) and Mz/Mw are measured by GPC according to the Gel Permeation Chromatography (GPC) Analytical Method for Polypropylene. The polymers are analyzed on Polymer Char High Temperature GPC with IR5 MCT (Mercury Cadmium Telluride-high sensitivity, thermoelectrically cooled IR detector), Polymer Char four capillary viscometer, a Wyatt 8 angle MALLS and three Agilent Plgel Olexis (13 um). The oven temperature is set at 150° C. The solvent is nitrogen purged 1,2,4-trichlorobenzene (TCB) containing approximately 200 ppm 2,6-di-t-butyl-4-methylphenol (BHT). The flow rate is 1.0 mL/min and the injection volume is 200 μl. A 2 mg/mL sample concentration is prepared by dissolving the sample in N2 purged and preheated TCB (containing 200 ppm BHT) for 2 hours at 160° C., with gentle agitation. Terpolymers made according to the present disclosure can have a MWD of greater than about 3, such as greater than about 4, such as greater than about 4.8 and less than about 8, such as less than about 7.

The GPC column set is calibrated by running twenty narrow molecular weight distribution polystyrene standards. The molecular weight (MW) of the standards ranges from 266 to 12,000,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 160° C. for 60 min under stirring. The narrow standards mixtures are run first and in order of decreasing highest molecular weight component to minimize degradation effect. A logarithmic molecular weight calibration is generated using a fourth-order polynomial fit as a function of elution volume. The equivalent polypropylene molecular weights are calculated by using following equation with reported Mark-Houwink coefficients for polypropylene (Scholte et. al. J. Appl. Polym. Sei., 29, 3763-3782 (1984)) and polystyrene (Otocka et. al Macromolecules, 4, 507 (1971));

$$\text{?} = ( \frac{\text{?}}{\text{?}} \text{?}$$

$$\text{?} \text{indicates text missing or illegible when filed}$$

where Mₚₚ is PP equivalent MW, M_{PS} is PS equivalent MW, log K and a values of Mark-Houwink coefficients for PP and PS are listed below in the Table below.

TABLE

| Polymer | A | Log K |
|---|---|---|
| Polypropylene | 0.725 | −3.721 |
| Polystyrene | 0.702 | −3.900 |

The melting point or melting temperature and the crystallization temperature are determined using differential scanning calorimetry (DSC). The melting point is the primary peak that is formed during the test and is typically the second peak that forms. The term “crystallinity” refers to the regularity of the arrangement of atoms or molecules forming a crystal structure. Polymer crystallinity can be examined using DSC. Tme means the temperature at which the melting ends and Tₘₐₓ means the peak melting temperature, both as determined by one of ordinary skill in the art from DSC analysis using data from the final heating step. One suitable method for DSC analysis uses a model Q1000™ M DSC from TA Instruments, Inc. Calibration of the DSC is performed in the following manner. First, a baseline is obtained by heating the cell from −90° C. to 290° C. without any sample in the aluminum DSC pan. Then 7 milligrams of a fresh indium sample is analyzed by heating the sample to 180° C., cooling the sample to 140° C. at a cooling rate of 10° C./min followed by keeping the sample isothermally at 140° C. for 1 minute, followed by heating the sample from 140° C. to 180° C. at a heating rate of 10° C./min. The heat of fusion and the onset of melting of the indium sample are determined and checked to be within 0.5° C. from 156.6° C. for the onset of melting and within 0.5 J/g from 28.71 J/g for the heat of fusion. Then deionized water is analyzed by cooling a small drop of fresh sample in the DSC pan from 25°° C. to −30° C. at a cooling rate of 10° C./min. The sample is kept isothermally at −30° C. for 2 minutes and heated to 30° C. at a heating rate of 10° C./min. The onset of melting is determined and checked to be within 0.5°° C. from 0° C.

One method of determining crystallinity in the high crystalline polypropylene polymer is by differential scanning calorimetry (DSC). A small sample (milligram size) of the propylene polymer is sealed into an aluminum DSC pan. The sample is placed into a DSC cell with a 25 centimeter per minute nitrogen purge and cooled to about −80° C. A standard thermal history is established for the sample by heating at 10° C. per minute to 225° C. The sample is then cooled to about −80° C. and reheated at 10° C. per minute to 225° C. The observed heat of fusion (ΔH_{observed}) for the second scan is recorded. The observed heat of fusion is related to the degree of crystallinity in weight percent based on the weight of the polypropylene sample by the following equation:

$$Crystallinity , \% = \frac{Δ {H}_{observed}}{Δ {H}_{isotactic PP}} \times 100$$

where the heat of fusion for isotactic polypropylene (ΔH_{isotactic PP}), as reported in Macromolecular Physics, Volume 3, Crystal Melting, Academic Press, New Your, 1980, p 48, is 164.92 Joules per gram (J/g) of polymer. Terpolymers of the present disclosure can have a crystallinity of less than about 60% , such as less than about 55% , such as less than about 50% , such as less than about 45% , and greater than about 25% , such as greater than about 35% .

Alternatively, crystallinity may also be determined using a heat of crystallization upon heating (HCH) method. In a HCH method, a sample is equilibrated at 200° C. and held at the temperature for three minutes. After the isothermal step, data storage is turned on, and the sample is ramped to −80° C. at 10° C. per minute. When −80° C. is reached, the data sampling is turned off, and the sample is held at the temperature for three minutes. After the second isothermal step, the data storage is turned on and the sample is ramped to 200° C. at 10° C. per minute.

The term “heat seal initiation temperature” (HSIT) is defined as the sealing temperature when heat seal strength first begins to trend upward from zero heat seal strength on the heat seal curve using a sealed film. The HSIT measurement can be performed at Bruckner's film testing commercial laboratory using the BMS TT 03 method. The film is sealed with Brugger HSG-CC heat sealing machine at the selected temperature under 1 bar pressure and 1 second dwell time. The sealed film is cut into 15 mm wide strips. The sealing strength is tested on a Zwick tensile strength machine with the film gripped by clamps of the tensile testing machine and pulled apart with a 180° angle between the grips. The heat seal initiation temperature (HSIT) is determined as the sealing temperature at which a sealing strength of 1.0 N/15 mm is achieved.

Film haze was measured following ASTM D1003 method. A homopolymer polypropylene was used as core layer (B) and the terpolymer was used as skin layers (A), The film structure is an ABA three layer structure. Total film thickness is ˜20 um with core layer and skin layer ratio at 90:10. Films made according the present disclosure can display a haze of less than about 1%, such as less than about 0.8%, such as less than about 0.6% and greater than about 0.1%.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms

“approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the present disclosure is directed to a propylene terpolymer that exhibits a lower melting temperature while still retaining excellent mechanical and physical properties. The propylene terpolymer is particularly well suited for forming a heat seal layer on various different articles, such as packaging films. The propylene terpolymer, for instance, can display a reduced heat seal initiation temperature. In this regard, when used to produce packages, heat seal layers made from the propylene terpolymer enables decreased sealing times, reduced cycle times, and greater production rates in comparison to heat seal layers made in the past. In one aspect, the propylene terpolymer is formed without having to substantially increase comonomer levels in comparison to similar terpolymers made in the past. In addition, the propylene terpolymers can be formed with relatively low ethylene content.

Multilayer films containing at least one exterior heat seal layer are used to form all different types of packages. The packages can be flexible or can be rigid. The packages can be used to hold and store a limitless variety of items including, for example, snack foods, candy, hardware, all other types of foodstuffs, consumer products, and the like. The heat seal layer is used to seal two opposing film layers together using heat and pressure before and after the package has been filled with its contents.

The heat seal layer that is used to seal packages and other containers ideally has a relatively low melting temperature and/or heat seal initiation temperature. For example, during the heat seal process, the temperature needed to initiate sealing of the package through use of the heat seal layer should be lower than the softening point of the primary film layer so that the package does not degrade, wrinkle or pucker during the sealing process.

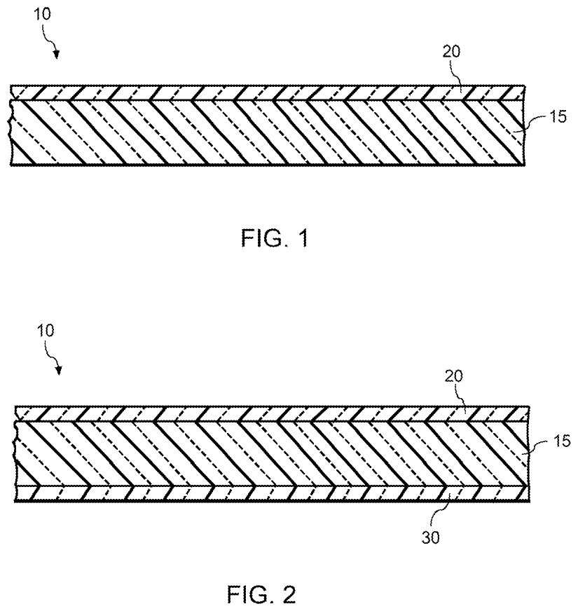

Referring to FIGS. 1 and 2, various embodiments of multilayer films made in accordance with the present disclosure are shown for exemplary purposes only. As shown in FIG. 1, the multilayer film 10, in this embodiment, includes a primary film layer 15 adjacent a heat seal layer 20 made in accordance with the present disclosure. In particular, the heat seal layer 20 is made from a propylene terpolymer. The heat seal layer 20 forms an exterior surface of the multilayer film 10 and can be used to thermally bond the film to an adjacent film layer. In one embodiment, a package can be formed by folding the multilayer film 10 onto itself such that the heat seal layer 20 faces an opposing heat seal layer. The two heat seal layers can then be thermally bonded together for forming a package.

In the embodiment illustrated in FIG. 1, the primary film layer 15 is shown as a single layer. It should be understood, however, that the primary film layer 15 can also be made from multiple layers of different thermoplastic polymers. Thermoplastic polymers that can be used to produce one or more primary film layers 15 include polyolefins, such as polypropylene, polyethylene, polybutylene, polystyrene, polyvinyl chloride, ethylene containing copolymers, propylene containing copolymers, and blends thereof. Metallized layers can also be present in the primary film layer and can form an outer layer if desired. Other suitable thermoplastic polymers that may be used to produce film layers include various polyesters, such as polyethylene terephthalate, polybutylene terephthalate, polyethylene terephthalate glycol, polyethylene naphthalate, polyamides, and the like.

Referring to FIG. 2, an alternative embodiment of a multilayer film 10 is shown. Like reference numerals have been used to indicate similar elements. In the embodiment in FIG. 2, the multilayer film 10 includes a primary film layer 15, a first heat seal layer 20 and a second heat seal layer 30. As shown, the heat seal layers 20 and 30 form the exterior surfaces of the film 10. The heat seal layers 20 and 30 can be formed from the propylene terpolymer of the present disclosure.

As represented in FIGS. 1 and 2, the heat seal layers 20 and 30 are relatively thin in relation to the thickness of the entire film 10. For example, the heat seal layers 20 and 30 can have a thickness of less than about 20 microns, such as less than about 10 microns, such as less than about 5 microns, such as less than about 4 microns, such as less than about 3 microns, such as less than about 2 microns, and generally greater than about 0.1 microns, such as greater than about 0.5 microns, such as greater than about 1 micron. The multilayer film 10, on the other hand, can have a thickness of up to about 250 microns, such as less than about 225 microns, such as less than about 200 microns, such as less than about 175 microns, such as less than about 150 microns, such as less than about 125 microns, such as less than about 100 microns, such as less than about 75 microns, such as less than about 50 microns, and generally greater than about 10 microns, such as greater than about 20 microns, such as greater than about 25 microns, such as greater than about 35 microns, such as greater than about 45 microns, such as greater than about 55 microns, such as greater than about 65 microns, such as greater than about 75 microns, such as greater than about 100 microns.

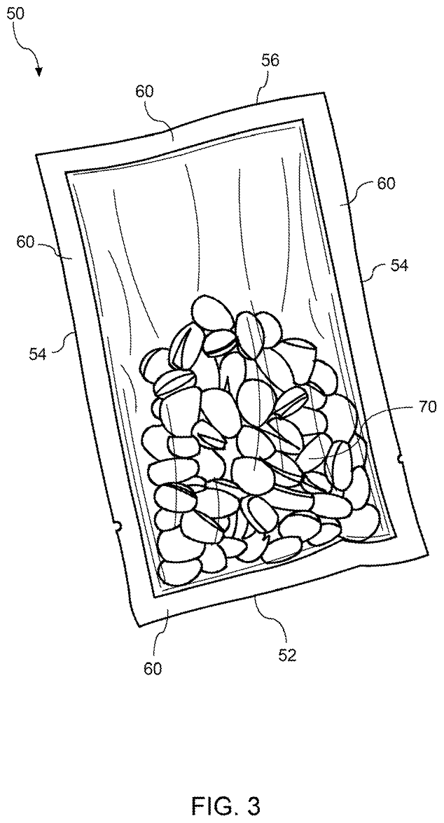

As an illustration, referring to FIG. 3, a package 50 that may be formed in accordance with the present disclosure is shown. The package 50 can be made from the multilayer film 10 either illustrated in FIG. 1 or 2. The package 50 includes a bottom 52, sides 54, and a top 56. The package 50, in this embodiment, is formed from two opposing flexible films. Each side of the package can be made from an individual piece of film or can be formed by folding a film in an overlapping relationship. The heat seal layers 20 and 30 of the present disclosure can be used to seal the margins of the package. For instance, as shown in FIG. 3, the package includes sealed margins 60 formed by applying heat and pressure to the heat seal layers.

As shown, the package 50 contains an item 70, such as a food product. Packages made according to the present disclosure can be used to contain and seal various different products, such as snack foods, hardware, consumer products, or the like. In addition, the package 50 can be used to contain flowable materials, such as liquids, including water, fruit juice, and the like. The package 50 can also be used to contain flowable gels, such as shampoos, conditioners, other hair products, toothpaste, and the like.

When filling packages as shown in FIG. 3, typically two layers of film are brought together and sealed at the margins to produce a hollow interior with a volume. A product or products are then loaded into the hollow interior and the remaining side of the package is heat sealed. In order to heat seal the package, the open end of the package is typically engaged with a sealing device that applies heat and pressure in an amount sufficient for the heat seal layers to activate and form thermal bonds. The faster the package is routed through the filling and sealing process, the more economical the packaging process. In this regard, the present disclosure is generally directed to producing a heat seal layer from a propylene terpolymer that has a lower melting temperature and a reduced heat seal initiation temperature. It was discovered that the propylene terpolymer of the present disclosure can dramatically reduce the sealing time and/or the sealing temperature which can lead to a substantial increase in productivity.

In accordance with the present disclosure, propylene terpolymers are produced with lower melting temperatures and/or reduced heat seal initiation temperatures by constructing the polymers with a more random and/or more evenly distributed ethylene content. It is believed that the more random ethylene distribution results in reduced polymer crystallinity resulting in reduced melting temperature and a lower heat seal temperature.

The propylene terpolymers can be made using a Ziegler-Natta catalyst. The Ziegler-Natta catalyst can include a base catalyst component in combination with an internal electron donor. The internal electron donor, for instance, can be a substituted phenyl diester. During polymerization, the base catalyst component as described above is combined with a co-catalyst and one or more external electron donors. The external electron donors, for instance, can be one or more activity limiting agents. Through the use of the above Ziegler-Natta catalyst, the propylene terpolymers can be constructed by controlling process conditions and monomer and comonomer addition rates. Although unknown, it is believed that the catalyst system as described above can contribute to the more random ethylene content and produce polymers not capable of being produced using other catalyst systems, such as catalyst systems that use phthalate-based components, diether-based components, and succinate-based components. In fact, one advantage of polymers made according to the present disclosure is that the polymers can be phthalate-free.

The propylene terpolymer of the present disclosure can include a majority weight percent propylene monomer combined with at least two other monomers. The comonomers can be two or more alpha-olefins. The comonomers, for instance, can be ethylene and butene (1-butene).

The propylene content of the propylene terpolymer, for instance, is generally greater than about 87% by weight, such as greater than about 89% by weight, such as greater than about 91% by weight, such as greater than about 93% by weight, such as greater than about 95% by weight. The total propylene content of the propylene terpolymer is generally less than about 98% by weight, such as less than about 96% by weight, such as less than about 94% by weight, such as less than about 92% by weight. The total comonomer content of the propylene terpolymer can be from about 2% by weight to about 15% by weight. For example, the total comonomer content of the propylene terpolymer can be less than about 13% by weight, such as less than about 11% by weight, such as less than about 9% by weight, and generally greater than about 3% by weight, such as greater than about 5% by weight.

As described above, in one embodiment, the propylene terpolymer is an ethylene/butene/propylene terpolymer. The ethylene content of the terpolymer can generally be greater than about 1% by weight, such as greater than about 1.5% by weight, such as greater than about 2% by weight, such as greater than about 2.5% by weight, such as greater than about 3% by weight. The ethylene content of the terpolymer is generally less than about 5% by weight, such as less than about 4.5% by weight, such as less than about 4% by weight, such as less than about 3.5% by weight, such as less than about 3.3% by weight, such as less than about 3% by weight.

One advantage of the propylene terpolymer of the present disclosure is the ability to produce the polymer with relatively low ethylene monomer content. Maintaining lower ethylene monomer content can lead the production of polymers with less particle agglomeration and a resin that is easier to handle.

The butene content of the propylene terpolymer can generally be from about 1% by weight to about 15% by weight, and in one embodiment less than 8% by weight. For example, the butene content can be less than about 7.5% by weight, such as less than about 7.3% by weight, such as less than about 6.9% by weight. The butene content is generally greater than about 2% by weight, such as greater than about 3% by weight, such as greater than about 5% by weight.

The propylene terpolymer of the present disclosure generally has a xylene soluble (XS) content of from about 2% to about 45% by weight. For instance, the xylene soluble content can be less than about 40% by weight, such as less than about 30% by weight, such as less than about 20% by weight, and generally greater than about 2% by weight, such as greater than about 4% by weight, such as greater than about 5% by weight. In one aspect, the propylene terpolymer can have a relatively low xylene soluble content. For example, the propylene terpolymer can have a xylene soluble content of less than about 10% by weight, such as less than about 9% by weight, such as less than about 8% by weight.

The propylene terpolymer present in the composition can generally have a melt flow index (MFI) ranging from about 1 to about 30 g/10 min, though polypropylenes having a higher or lower melt flow index are also encompassed herein. For example, the propylene terpolymer may have a melt flow index of greater than about 2 g/10 min, such as greater than about 3 g/10 min, such as greater than about 4 g/10 min. The melt flow index of the propylene terpolymer can be less than about 18 g/10 min, such as less than about 16 g/10 min, such as less than about 14 g/10 min, or less than about 10 g/10 min.

Heat seal layers made according to the present disclosure can be formed from a polypropylene polymer composition containing the propylene terpolymer alone or in combination with various other components. The propylene terpolymer may be present in the propylene terpolymer composition in an amount of at least 50 wt. %, such as at least 60 wt. %, such as at least 70 wt. %, such as at least 80 wt. %, such as at least 90 wt. %, such as at least 95 wt. %, such as at least 96 wt. %. In one embodiment, the propylene terpolymer composition can contain almost exclusively the propylene terpolymer. For example, the propylene terpolymer can be present in an amount greater than about 96% by weight, such as in an amount greater than about 97% by weight, such as in an amount greater than about 98% by weight, such as in an amount greater than about 99% by weight.

In one embodiment, the propylene terpolymer of the present disclosure can be peroxide cracked, which can increase the melt flow rate and decrease the molecular weight distribution.

Peroxide cracking is also referred to as a visbreaking process. During visbreaking, higher molar mass chains of the propylene terpolymer are broken in relation to the lower molar mass chains. Visbreaking results in an overall decrease in the average molecular weight of the polymer and an increase in the melt flow rate. Visbreaking can produce a polymer with a lower molecular weight distribution or polydispersity index. The amount of visbreaking that occurs within the polymer can be quantified using a cracking ratio. The cracking ratio is calculated by dividing the final melt flow rate of the polymer by the initial melt flow rate of the polymer.

The propylene terpolymer can be subjected to visbreaking according to the present disclosure using a peroxide as a visbreaking agent. Typical peroxide visbreaking agents are 3,6,9-triethyl-3,6,9-trimethyl-1,4,7-triperoxonane, 2,5-dimethyl-2,5-bis(tert.butyl-peroxy)hexane (DHBP), 2,5-dimethyl-2,5-bis(tert.butyl-peroxy)hexyne-3 (DYBP), dicumyl-peroxide (DCUP), di-tert.butyl-peroxide (DTBP), tert.butyl-cumyl-peroxide (BCUP) and bis (tert.butylperoxy-isopropyl)benzene (DIPP). The above peroxides can be used alone or in a blend.

Visbreaking the propylene terpolymer can be carried out during melt processing in a first extruder. For instance, the propylene terpolymer can be fed through the extruder and the visbreaking agent can be added to the extruder once the polymer is in a molten state. Alternatively, the visbreaking agent can be preblended with the propylene terpolymer. In one aspect, for instance, the visbreaking agent can be first compounded with a polymer, such as a propylene terpolymer to form a masterbatch. The masterbatch containing the visbreaking agent can then be blended with the propylene terpolymer and fed through the extruder. In still another aspect, the visbreaking agent can be physically blended with the propylene terpolymer, such as being imbibed on the polymer powder. In general, any suitable extruder can be used during visbreaking. For instance, the extruder can be a single-screw extruder, a contra-rotating twin-screw extruder, a co-rotating twin-screw extruder, a planetary-gear extruder, a ring extruder, or any suitable kneading apparatus.

The amount of visbreaking agent added to the propylene terpolymer can depend upon various factors, including the cracking ratio that is desired. In general, the visbreaking agent or peroxide can be added to the propylene terpolymer in an amount greater than about 0.001% by weight, such as greater than about 0.005% by weight, such as greater than about 0.01% by weight, such as greater than about 0.015% by weight, such as greater than about 0.02% by weight, such as greater than about 0.04% by weight, such as greater than about 0.05% by weight, such as greater than about 0.08% by weight, In general, the visbreaking agent is added to the propylene terpolymer in an amount less than about 0.2% by weight, such as in an amount less than about 0.15% by weight, such as in an amount less than about 0.1% by weight.

In general, the propylene terpolymer can be subjected to visbreaking so as to have a cracking ratio of greater than about 1.1, such as greater than about 1.3, such as greater than about 1.5, such as greater than about 1.7, such as greater than about 2, and generally less than about 10, such as less than about 5, such as less than about 3, such as less than about 2.5. The cracking ratio is calculated by dividing the final melt flow rate of the polymer by the initial melt flow rate of the polymer.

As described above, the propylene terpolymer is constructed in accordance with the present disclosure so as to have a more random ethylene distribution. Ethylene distribution within the terpolymer can be related to the sequence length, which is defined by the following equation:

$$nE = 2 \text{?} \frac{( EE + \frac{PE}{2} + \frac{BE}{2} )}{( PE + BE )}$$

$$\text{?} \text{indicates text missing or illegible when filed}$$

Based on the sequence length defined above, propylene terpolymers made according to the present disclosure in one embodiment, have a particular sequence length distribution for ethylene that is defined by the following equation:

$$nE < 0.0 \; 353 Et + 1.08$$

wherein Et is the ethylene content by weight. In particular embodiments, the propylene terpolymer can have a sequence length distribution of ethylene of less than 1.26, such as less than 1.24, such as less than about 1.22, such as less than about 1.2, such as less than about 1.18, such as less than about 1.15. The sequence length distribution of ethylene contained within the terpolymer is generally greater than 1, such as greater than about 1.05.

It is believed that a more random ethylene distribution in the terpolymer results in reduced polymer crystallinity which, in turn, results in a reduced melting temperature and a lower heat seal temperature. The melting temperature of the propylene terpolymer, for instance, can be less than about 140° C., such as less than about 135° C., such as less than about 132° C., such as less than about 130° C., such as less than about 129° C., such as less than about 127° C., such as less than about 125° C. The melting temperature is generally greater than 110° C., such as greater than about 115° C., such as greater than about 120° C. The heat seal initiation temperature of the propylene terpolymer is less than 110° C., such as less than about 109° C., such as less than about 108° C., and generally greater than about 80° C., such as greater than about 90° C., such as greater than 100° C.

The propylene terpolymer of the present disclosure can be formed in different ways. In one embodiment, the polymer is Ziegler-Natta catalyzed. The catalyst, for instance, can include a solid catalyst component that can vary depending upon the particular application.

The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{c})fX_{g} wherein R^{c} is an aliphatic or aromatic hydrocarbon radical having 1 to 14 carbon atoms or COR′ wherein R′is an aliphatic or aromatic hydrocarbon radical having 1 to 14 carbon atoms; each ORe group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain-Si—O—Si-groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

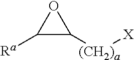

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into non agglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 15-150 microns, preferably between 20-100 microns, and most preferably between 35-85 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

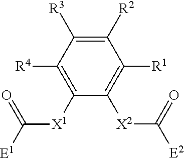

wherein R¹, R², R³, and R⁴ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X¹ and X² are each O, S, an alkyl group, or NRs and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

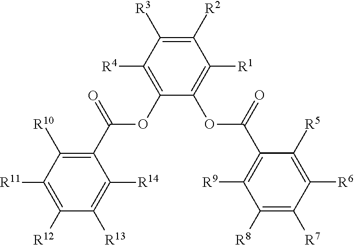

In an embodiment, structure (I) includes R¹ and R³ that is an isopropyl group. Each of R², R⁴ and R⁵-R¹⁴ is hydrogen.

In an embodiment, structure (I) includes each of R¹ and R⁴, as a methyl group and R₃ is a cycloalkyl group, such as a cyclohexyl group. Each of R² and R⁵-R¹⁴ are hydrogen.

In an embodiment, structure (I) includes each of R¹, R⁵, and R¹⁰ as a methyl group and R³ is a t-butyl group. Each of R², R⁴, R⁶-R⁹, and R¹¹-R¹⁴ is hydrogen.

In an embodiment, structure (I) includes each of R¹, R⁷, and R¹² as a methyl group and R³ is a t-butyl group. Each of R², R⁴, R⁵, R⁶, R⁸, R⁹, R¹⁰, R¹¹, R¹³, and R¹⁴ is hydrogen.

In an embodiment, structure (I) includes R¹ as a methyl group and R³ is a t-butyl group. Each of R⁷ and R¹² is an ethyl group. Each of R², R⁴, R⁵, R⁶, R⁸, R⁹, R¹⁰, R¹¹, R¹³, and R¹⁴ is hydrogen.

In an embodiment, structure (I) includes each of R¹, R⁵, R⁷, R⁹, R¹⁰, R¹², and R¹⁴ as a methyl group and R³ is a t-butyl group. Each of R², R⁴, R⁶, R⁸, R¹¹, and R¹³ is hydrogen.

In an embodiment, structure (I) includes R₁ as a methyl group and R³ is a t-butyl group. Each of R⁵, R⁷, R⁹, R¹⁰, R¹², and R¹⁴ is an i-propyl group. Each of R², R⁴, R⁶, R⁸, R¹¹, and R¹³ is hydrogen.

In an embodiment, the substituted phenylene aromatic diester has a structure selected from the group consisting of structures (II)-(V), including alternatives for each of R¹ to R¹⁴, that are described in detail in U.S. Pat. No. 8,536,372, which is incorporated herein by reference.

In an embodiment, structure (1) includes Rª that is a methyl group and R³ is a t-butyl group. Each of R⁷ and R¹² is an ethoxy group. Each of R², R⁴, R⁵, R⁶, R⁸, R⁹, R¹⁰, R¹¹, R¹³, and R¹⁴ is hydrogen.

In an embodiment, structure (I) includes R′ that is a methyl group and R³is a t-butyl group. Each of R⁷ and R¹² is a fluorine atom. Each of R², R⁴, R⁵, R⁶, R⁸, R⁹, R¹⁰, R¹¹, R¹³, and R¹⁴ is hydrogen.

In an embodiment, structure (1) includes Rª that is a methyl group and R³ is a t-butyl group. Each of R⁷ and R¹² is a chlorine atom. Each of R², R⁴, R⁵, R⁶, R⁸, R⁹, R¹⁰, R¹¹, R¹³, and R¹⁴ is hydrogen.

In an embodiment, structure (I) includes R¹ that is a methyl group and R³ is a t-butyl group. Each of R⁷ and R¹² is a bromine atom. Each of R², R⁴, R⁵, R⁶, R⁸, R⁹, R¹⁰, R¹¹, R¹³, and R¹⁴ is hydrogen.

In an embodiment, structure (I) includes R¹ that is a methyl group and R³ is a t-butyl group. Each of R⁷ and R¹² is an iodine atom. Each of R², R⁴, R⁵, R⁶, R⁸, R⁹, R¹⁰, R¹¹, R¹³, and R¹⁴ is hydrogen.

In an embodiment, structure (I) includes R¹ that is a methyl group and R³ is a t-butyl group. Each of R⁶, R⁷, R¹¹, and R¹² is a chlorine atom. Each of R², R⁴, R⁵, R⁶, R⁸, R⁹, R¹⁰, R¹¹, R¹³, and R¹⁴ is hydrogen.

In an embodiment, structure (I) includes R¹ that is a methyl group and R³ is a t-butyl group. Each of R⁶, R⁷, R¹¹, and R¹² is a chlorine atom. Each of R², R⁴, R⁵, R⁷, R⁹, R¹⁰, R¹², and R¹⁴ is hydrogen.

In an embodiment, structure (I) includes R¹ that is a methyl group and R³ is a t-butyl group. Each of R², R⁴, and R⁵-R¹⁴ is a fluorine atom.

In an embodiment, structure (I) includes R¹ that is a methyl group and R³ is a t-butyl group. Each of R⁷ and R¹² is a trifluoromethyl group. Each of R², R⁴, R⁵, R⁶, R⁸, R⁹, R¹⁰, R¹¹, R¹³, and R¹⁴ is hydrogen.

In an embodiment, structure (I) includes R¹ that is a methyl group and R³ is a t-butyl group. Each of R⁷ and R¹² is an ethoxycarbonyl group. Each of R², R⁴, R⁵, R⁶, R⁸, R⁹, R¹⁰, R¹¹, R¹³, and R¹⁴ is hydrogen.

In an embodiment, R¹ is a methyl group and R³ is a t-butyl group. Each of R₇ and R₁₂ is an ethoxy group. Each of R², R⁴, R⁵, R⁶, R⁸, R⁹, R¹⁰, R¹¹, R¹³ and R¹⁴ is hydrogen.

In an embodiment, structure (I) includes R¹ that is a methyl group and R³ is a t-butyl group. Each of R⁷ and R¹² is a diethylamino group. Each of R², R⁴, R⁵, R⁶, R⁸, R⁹, R¹¹, R¹², R¹³, and R¹⁴ is hydrogen.

In an embodiment, structure (I) includes R¹ that is a methyl group and R³is a 2,4,4-trimethylpentan-2-yl group. Each of R², R⁴, and R⁵-R¹⁴ is hydrogen.

In an embodiment, structure (I) includes R¹ and R³, each of which is a sec-butyl group. Each of R², R⁴, and R⁵-R¹⁴ is hydrogen.

In an embodiment, structure (I) includes R¹ and R⁴ that are each a methyl group Each of R², R³, R⁵-R⁹, and R¹⁰-R¹⁴ is hydrogen.

In an embodiment, structure (I) includes R¹ that is a methyl group. R⁴ is an i-propyl group. Each of R², R³, R⁵-R⁹, and R¹⁰-R¹⁴ is hydrogen.

In an embodiment, structure (1) includes R¹, R³, and R⁴, each of which is an i-propyl group Each of R², R⁵-R⁹, and R¹⁰-R¹⁴ is hydrogen

In addition to the solid catalyst component as described above, the catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, and n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more activity limiting agents (ALA) and/or one or more selectivity control agents (SCA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiR²⁰ₘ(OR²¹)₄₋ₘ (I) where R²⁰ independently each occurrence is hydrogen or a hydrocarbyl or an amino group optionally substituted with one or more substituents containing one or more Group 14, 15, 16, or 17 heteroatoms, said R²⁰ containing up to 20 atoms not counting hydrogen and halogen; R²¹ is a C₁₋₄ alkyl group; and m is 0, 1, 2 or 3. In an embodiment, R²⁰ is C₆₋₁₂ aryl, alkyl or aralkyl, C₃₋₁₂ cycloalkyl, C₃₋₁₂ branched alkyl, or C₃₋₁₂ cyclic or acyclic amino group, R²¹ is C₁₋₄ alkyl, and m is 1 or 2. In one embodiment, for instance, the second selectivity control agent may comprise n-propyltriethoxysilane. Other selectively control agents that can be used include propyltriethoxysilane or diisobutyldimethoxysilane.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono-or a poly-(two or more) ester, may be straight chain or branched, may be saturated or unsaturated, and any combination thereof. The C₄-C₃₀ aliphatic acid ester may also be substituted with one or more Group 14, 15, or 16 heteroatom containing substituents. Nonlimiting examples of suitable C₄₋₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono-and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono-or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono-or diacetates, (poly)(alkylene glycol) mono-or di-myristates, (poly)(alkylene glycol) mono-or di-laurates, (poly)(alkylene glycol) mono-or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

The catalyst system of the present disclosure as described above can be used for producing olefin-based polymers. The process includes contacting an olefin with the catalyst system under polymerization conditions.

In one embodiment, polymerization occurs by way of gas phase polymerization. As used herein, “gas phase polymerization” is the passage of an ascending fluidizing medium, the fluidizing medium containing one or more monomers, in the presence of a catalyst through a fluidized bed of polymer particles maintained in a fluidized state by the fluidizing medium. “Fluidization,” “fluidized,” or “fluidizing” is a gas-solid contacting process in which a bed of finely divided polymer particles is lifted and agitated by a rising stream of gas. Fluidization occurs in a bed of particulates when an upward flow of fluid through the interstices of the bed of particles attains a pressure differential and frictional resistance increment exceeding particulate weight. Thus, a “fluidized bed” is a plurality of polymer particles suspended in a fluidized state by a stream of a fluidizing medium. A “fluidizing medium” is one or more olefin gases, optionally a carrier gas (such as H₂ or N₂) and optionally a liquid (such as a hydrocarbon) which ascends through the gas-phase reactor.

A typical gas-phase polymerization reactor (or gas phase reactor) includes a vessel (i.e., the reactor), the fluidized bed, a distribution plate, inlet and outlet piping, a compressor, a cycle gas cooler or heat exchanger, and a product discharge system. The vessel includes a reaction zone and a velocity reduction zone, each of which is located above the distribution plate. The bed is located in the reaction zone. In an embodiment, the fluidizing medium includes propylene gas and at least one other gas such as an olefin and/or a carrier gas such as hydrogen or nitrogen.

In one embodiment, the contacting occurs by way of feeding the catalyst composition into a polymerization reactor and introducing the olefin into the polymerization reactor.

In addition to gas phase polymerization processes, however, it should also be understood that the catalyst system of the present disclosure can also be used in all different types of bulk phase polymerization processes including slurry systems with loop reactors.

Propylene terpolymers made according to the present disclosure can then be incorporated into various polymer compositions for producing articles, such as film layers and/or heat seal layers. The polymer composition can contain the propylene terpolymer in combination with various other components.

In one aspect, the polymer composition can contain a primary antioxidant, a secondary antioxidant (e.g. phosphite), and an antacid (e.g. CaSt or ZnO). In one aspect, the antioxidant has anti-gas fading properties such as Irganox 3114, Cyanox 1790, or Irganox 1425WL. Alternately, the antioxidant system can be non-gas fading, i.e. free of phenolic antioxidants, and be based on a combination of HALS (hindered amine light stabilizer) with either/both a hydroxylamine stabilizer (e.g. Irganox FS042) and a phosphite secondary antioxidant. The antioxidant can minimize the oxidation of polymer components and organic additives in the polymer blends. The polymer composition, for instance, can contain a phosphite and/or phosphonate antioxidant alone or in combination with other antioxidants. Non-limiting examples of suitable antioxidants include phenols such as 2,6-di-t-butyl-4-methylphenol; 1,3,5-trimethyl-2,4,6-tris(3′,5′-di-t-butyl-4′-hydroxybenzyl)benzene; tetrakis[(methylene(3,5-di-t-butyl-4-hydroxyhydrocinnamate)]methane; acryloyl modified phenols; octadecyl-3,5-di-t-butyl-4-hydroxycinnamate; 1,3,5-tris(3,5-di-tert-butyl-4-hydroxybenzyl)-1,3,5-triazine-2,4,6(1H,3H,5H)-trione (e.g. Irganox 3114 supplied by BASF); calcium-bis (((3,5-bis(1,1-dimethylethyl)-4-hydroxyphenyl)methyl)-ethylphosphonate) (e.g. Irganox 1425WL supplied by BASF). Another antioxidant than may be used is 1,3,5-triazine-2,4,6(1H,3H,5H)-trione, 1,3,5-tris[[4-(1, 1-dimethylethyl)-3-hydroxy-2,6-dimethylphenyl]methyl] (e.g. Cyanox 1790 from Sovay). In another aspect the antioxidant can be N,N-dioctadecylhydroxylamine (e.g. FS042). Phosphites and phosphonites may generally be used in combination with the above hindered phenols; hydroxylamines may generally be used in combination with a hindered amine light stabilizer or a phosphite. Other antioxidants include benzofuranone derivatives; and combinations thereof.

The polymer composition can also contain an antacid which operates as an acid scavenger. The antacid can be a stearate, a metal oxide, a hydrotalcite, magnesium aluminum hydroxide carbonate, or mixtures thereof. Examples of particular antacids include calcium stearate, zinc stearate, magnesium oxide, zinc oxide, and mixtures thereof.

The polymer composition can also contain a processing aid. An example of a processing aid is a fluorocarbon polymer. For instance, the composition can contain polytetrafluoroethylene particles. The processing aid can be present in an amount of from about 0% to about 5% by weight, such as from about 0.01% to about 1.5% by weight.

The polymer composition can also contain slip agents and anti-blocking agents. Slip agents includes amides, such as fatty amides. The term “anti-blocking agent” is used herein to describe substances that reduce the tendency of films or sheets of polymer film to stick or adhere to each other or to other surfaces when such adhesion is otherwise undesirable. Typical anti-blocking agents include colloidal silica, finely divided silica, clays, silicons, and certain amides and amines. These above agents are typically present in the film at a concentration in the outer layers of from about 500 ppm to about 20,000 ppm.

In some embodiments, the polymer composition can optionally include a stabilizer that may prevent or reduce the degradation of the polymer blends by UV radiation. Non-limiting examples of suitable UV stabilizers include benzophenones, hindered amines, benzotriazoles, aryl esters, oxanilides, acrylic esters, formamidines, carbon black, nickel quenchers, phenolic antioxidants, metallic salts, zinc compounds, and combinations thereof.

In one aspect, the polymer composition can also contain one or more coloring agents. The coloring agent can be a dye or a pigment. In one embodiment, a blend of coloring agents can be used in order to produce a filament with a particular color.

In one embodiment, the polymer composition can contain a nucleating agent. When utilized, the nucleating agent is not particularly limited. In one embodiment, the nucleating agent may be selected from the group of phosphorous based nucleating agents like phosphoric acid esters metal salts represented by the following structure (VIII).

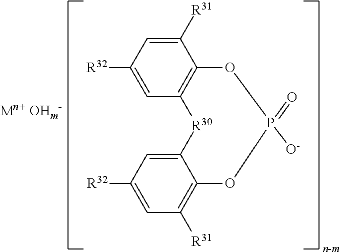

wherein R³⁰ is oxygen, sulfur or a hydrocarbon group of 1 to 10 carbon atoms; each of R³¹ and R³² is hydrogen or a hydrocarbon or a hydrocarbon group of 1 to 10 carbon atoms; R³¹ and R³² may be the same or different from each other, two of R³¹, two of R³², or R³¹ and R³² may be bonded together to form a ring, M is a monovalent to trivalent metal atom; n is an integer from 1 to 3 and m is either 0 or 1, provided that n>m.

Examples of alpha nucleating agents represented by the above formula include sodium-2,2′-methylene-bis(4,6-di-t-butyl-phenyl)phosphate, sodium-2,2′-ethylidene-bis(4,6-di-t-butylphenyl)-phos-phate, lithium-2,2′-methylene-bis(4,6-di-t-butylphenyl)phosphate, lithium-2,2′-ethylidene-bis(4,6-di-t-butylphenyl)phosphate, sodium-2,2′-ethylidene-bis(4-i-propyl-6-t-butylphenyl)phosphate, lithium-2,2′-methylene-bis(4-methyl-6-t-butylphenyl)phosphate, lithium-2,2′-methylene-bis(4-ethyl-6-t-butylphenyl)phosphate, calcium-bis[2,2′-thiobis(4-methyl-6-t-butyl-phenyl)-phosphate], calcium-bis[2,2′-thiobis(4-ethyl-6-t-butylphenyl)-phosphate], calcium-bis[2,2′-thiobis(4,6-di-t-butylphenyl)phosphate], magnesium-bis[2,2′-thiobis(4,6-di-t-butylphenyl)phosphate], magnesium-bis[2,2′-thiobis(4-t-octylphenyl)phosphate], sodium-2,2′-butylidene-bis(4,6-dimethylphenyl)phosphate, sodium-2,2′-butylidene-bis(4,6-di-t-butyl-phenyl)-phosphate, sodium-2,2′-t-octylmethylene-bis(4,6-dimethyl-phenyl)-phosphate, sodium-2,2′-t-octylmethylene-bis(4,6-di-t-butylphenyl)-phosphate, calcium-bis[2,2′-methylene-bis(4,6-di-t-butylphenyl)-phosphate], magnesium-bis[2,2′-methylene-bis(4,6-di-t-butylphenyl)-phosphate], barium-bis[2,2′-methylene-bis(4,6-di-t-butylphenyl)-phosphate], sodium-2,2′-methylene-bis(4-methyl-6-t-butylphenyl)-phosphate, sodium-2,2′-methylene-bis(4-ethyl-6-t-butylphenyl)phosphate, sodium(4,4′-dimethyl-5,6′-di-t-butyl-2,2′-biphenyl)phosphate, calcium-bis-[(4,4′-dimethyl-6,6′-di-t-butyl-2,2′-biphenyl)phosphate], sodium-2,2′-ethylidene-bis(4-m-butyl-6-t-butyl-phenyl)phosphate, sodium-2,2′-methylene-bis-(4,6-di-methylphenyl)-phos-phate, sodium-2,2′-methylene-bis(4,6-di-t-ethyl-phenyl)phosphate, potassium-2,2′-ethylidene-bis(4,6-di-t-butylphenyl)-phosphate, calcium-bis[2,2′-ethylidene-bis(4,6-di-t-butylphenyl)-phosphate], magnesium-bis[2,2′-ethyli-dene-bis(4,6-di-t-butylphenyl)-phosphate], barium-bis[2,2′-ethylidene-bis-(4,6-di-t-butylphenyl)-phosphate], aluminium-hydroxy-bis[2,2′-methylene-bis(4,6-di-t-butyl-phenyl)phosphate], and aluminium-tris[2,2′-ethylidene-bis(4,6-di-t-butylphenyl)-phosphate].

A second group of phosphorous based nucleating agents includes for example aluminium-hydroxy-bis[2,4,8,10-tetrakis(1,1-dimethylethyl)-6-hydroxy-12H-dibenzo-[d,g]-dioxa-phoshocin-6-oxidato] and blends thereof with Li-myristate or Li-stearate.

Other examples of nucleating agents can include, without limitation, sorbitol-based nucleating agents (e.g., 1,3:2,4 Dibenzylidene sorbitol, 1,3:2,4 Di(methylbenzylidene) sorbitol, 1,3:2,4 Di(ethylbenzylidene) sorbitol, 1,3:2,4 Bis(3,4-dimethylbenzylidene) sorbitol, etc.), pine rosin, polymeric nucleating agents (e.g., vinylcycloalkane polymers, vinylalkane polymers, partial metal salts of a rosinic acid, etc.), talc, sodium benzoate, etc.

Commercially available examples of nucleating agents can include, without limitation, ADK NA-11, ADK NA-21, ADK NA-21 E, ADK NA-21 F, and ADK NA-27 which are available from Asahi Denka Kokai; Millad NX8000, Millad 3988, Millad 3905, Millad 3940, Hyperform HPN-68L, Hyperform HPN-715, and Hyperform HPN-20E, which are available from Milliken & Company; and Irgaclear XT 386 from Ciba Specialty Chemicals.

When present in the polymer composition, one or more nucleating agents are generally added in an amount greater than about 100 ppm, such as in an amount greater than about 1,800 ppm, such as in an amount greater than about 2,000 ppm, such as in an amount greater than about 2,200 ppm. One or more nucleating agents are generally present in an amount less than about 20,000 ppm, such as less than about 15,000 ppm, such as less than about 10,000 ppm, such as less than about 8,000 ppm, such as less than about 5,000 ppm.

After the polymer composition is formulated containing the propylene terpolymer, the composition can be, in one embodiment, formed into a film layer, such as a heat seal layer.

The film forming process may include one or more of the following procedures: extrusion, coextrusion, cast extrusion, blown film formation, double bubble film formation, tenter frame techniques, calendaring, coating, dip coating, spray coating, lamination, biaxial orientation, injection molding, thermoforming, compression molding, and any combination of the foregoing.

In an embodiment, the process includes forming a multilayer film. The term “multilayer film” is a film having two or more layers. Layers of a multilayer film are bonded together by one or more of the following nonlimiting processes: coextrusion, extrusion coating, vapor deposition coating, solvent coating, emulsion coating, or suspension coating.

In an embodiment, the process includes forming an extruded film. The term “extrusion,” and like terms, is a process for forming continuous shapes by forcing a molten plastic material through a die, optionally followed by cooling or chemical hardening. Immediately prior to extrusion through the die, the relatively high-viscosity polymeric material is fed into a rotating screw, which forces it through the die. The extruder can be a single screw extruder, a multiple screw extruder, a disk extruder, or a ram extruder. The die can be a film die, blown film die, sheet die, pipe die, tubing die or profile extrusion die. Nonlimiting examples of extruded articles include pipe, film, and/or fibers.

In an embodiment, the process includes forming a coextruded film. The term “coextrusion,” and like terms, is a process for extruding two or more materials through a single die with two or more orifices arranged so that the extrudates merge or otherwise weld together into a laminar structure. At least one of the coextruded layers contains the present propylene-based polymer. Coextrusion may be employed as an aspect of other processes, for instance, in film blowing, casting film, and extrusion coating processes.

In an embodiment, the process includes forming a blown film. The term “blown film,” and like terms, is a film made by a process in which a polymer or copolymer is extruded to form a bubble filled with air or another gas in order to stretch the polymeric film. Then, the bubble is collapsed and collected in flat film form.

After formation of the multilayer film, the multilayer film can be used to form all different types of packaging in accordance with the present disclosure. For example, FIG. 3 is an exemplary embodiment of a package that may be made in accordance with the present disclosure.

The present invention, thus generally described, will be understood more readily by reference to the following examples, which are provided by way of illustration and are not intended to be limiting of the present invention.

### EXAMPLES

Six different propylene terpolymers were formulated and tested for melting temperature and heat seal initiation temperature (HSIT). Each terpolymer contained propylene as the primary monomer combined with ethylene and butene. The sequence length distribution for ethylene was calculated for Samples 1-3 and 6.

All of the propylene terpolymers were made using a Ziegler-Natta catalyst system. In Sample Nos. 1-4, the solid catalyst component contained a phenylene-substituted diester as the internal electron donor. Sample No. 5 was a commercially available propylene terpolymer. Sample No. 6 was formed in the presence of LYNX 1010, a phthalate-based catalyst commercially available from W. R. Grace. All the samples below except for Sample Nos. 1, 2 and 6 were visbroken. The following results were obtained:

| | Powder | Pellet | | | | | | | | | |
|---|---|---|---|---|---|---|---|---|---|---|---|
| | MFR | MFR | | | | | | | | | |
| Samp. | (g/10 | (g/10 | | | Film | HSIT | DSC Tm | Crystallinity | Et (wt %) | Bt (wt %) | |
| No. | min) | min) | XS % | MWD | haze (%) | (° C.) | (° C.) | (%) | (NMR) | (NMR) | nE |
| 1 | 3.3 | 4.2 | 5.8 | 5.0 | 0.54 | 108 | 128 | 42.6 | 2.4 | 6.9 | 1.13 |
| 2 | 7.0 | 7.5 | 7.7 | 6.4 | 0.43 | 106 | 126 | 40.3 | 2.8 | 6.9 | 1.17 |
| 3 | 3.5 | 5.7 | 36.4 | 5.0 | 0.40 | 93 | 116 | 33.2 | 2.0 | 14.5 | 1.22 |
| 4 | 3.4 | 7.0 | 11.2 | 4.7 | 0.52 | 101 | 124 | 37.2 | 2.6 | 8.5 | |
| 5 | | 5.5 | 7.4 | 4.7 | | 110 | 133 | 48.1 | 2.9 | 5.3 | |
| 6 | 5.4 | | 9.8 (v)* | 5.0 | | | 137 | 51.0 | 3.2 | 2.4 | 1.24 |

*measured using the Viscotek Flow Injection Polymer Analysis Method.

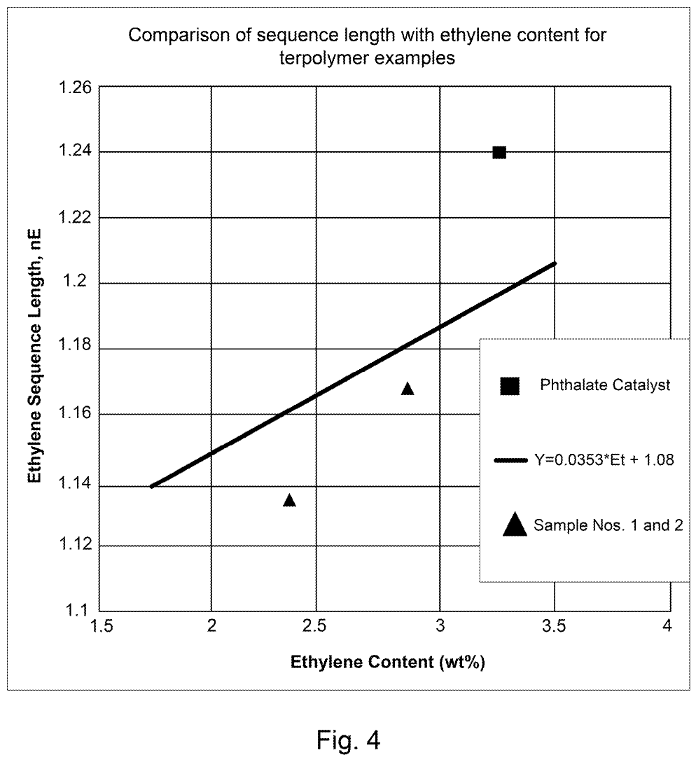

A comparison of sequence length with ethylene content for each of the propylene terpolymers is shown in FIG. 4. As shown in FIG. 4, Sample Nos. 1 and 2 displayed a very random ethylene distribution. These samples also demonstrated a very low melting temperature and heal seal initiation temperature while containing butene in an amount less than 8% by weight and particularly less than 7% by weight.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A propylene terpolymer comprising:
propylene as a primary monomer;
an ethylene content of from about 1% to about 5% by weight;
a butene content of from about 1% to less than 8% by weight; and
wherein the propylene terpolymer has a melt flow rate of from about 1 g/10 min to about 30 g/10 min, has a melting temperature of less than 140° C., and has a sequence length distribution of ethylene defined as follows:
$$nE < 0.0353 Et + 1.08$$
wherein Et is the ethylene content by weight.

2. The propylene terpolymer of claim 1, wherein the butene content is from about 3% to 7% by weight.

3. The propylene terpolymer of claim 1, wherein the terpolymer has a heat seal initiation temperature of less than about 115° C.

4. The propylene terpolymer of claim 1, wherein the terpolymer has a melting temperature of from about 110° C. to about 135° C.

5. The propylene terpolymer of claim 1, wherein the xylene soluble content is from about 2% to about 10% by weight.

6. The propylene terpolymer of claim 1, wherein the terpolymer has a melt flow rate of from about 2 g/10 min to about 20 g/10 min.

7. The propylene terpolymer of claim 1, wherein the terpolymer has an ethylene content of from about 1.5% by weight to about 3.5% by weight.

8. The propylene terpolymer of claim 1, wherein the terpolymer has been Ziegler-Natta catalyzed using a non-phthalate catalyst.

9. The propylene terpolymer of claim 1, wherein the terpolymer has a propylene content of from about 87% by weight to about 98% by weight.

10. The propylene terpolymer of claim 1, wherein the terpolymer has a sequence length distribution of ethylene of from about 1.00 to about 1.20.

11. A process for producing the propylene terpolymer of claim 1, wherein the terpolymer is a visbroken or in-reactor grade propylene terpolymer.

12. A process for producing the propylene terpolymer of claim 1, the process comprising polymerizing a propylene monomer, an ethylene monomer and a butene monomer in the presence of a Ziegler-Natta catalyst, the Ziegler-Natta catalyst including a catalyst component and an activity limiting agent, the solid catalyst component comprising a magnesium moiety, a titanium moiety, and an internal electron donor.

13. The process of claim 12, wherein the monomers are polymerized in the presence of the solid catalyst component and the activity limiting agent in a slurry loop reactor.

14. The process of claim 12, wherein the monomers are polymerized in the presence of the solid catalyst component and the activity limiting agent in a gas phase reactor.

15. The process of claim 12, wherein the internal electron donor comprises a substituted phenylene diester.

16. A polymer composition comprising the propylene terpolymer of claim 1, the propylene terpolymer being present in the polymer composition in an amount greater than about 70% by weight, such as in an amount greater than about 80% by weight, such as in an amount greater than about 90% by weight.

17. A polymer film layer comprising the propylene terpolymer of claim 1, the propylene terpolymer being present in the polymer film layer in an amount greater than about 70% by weight.

18. A multilayer film structure comprising:
a base layer comprising a thermoplastic polymer; and
a heat-seal layer comprising a propylene terpolymer, the propylene terpolymer comprising propylene as a primary monomer, an ethylene content of from about 1% to about 5% by weight; a butene content of greater than about 1% by weight, and wherein the propylene terpolymer has a melt flow rate of from about 1 g/10 min to about 20 g/10 min, a heat seal initiation temperature of less than about 110° C., and a sequence length distribution of ethylene defined as follows:
$$nE < 0.0 \; 353 Et + 1.08$$
wherein Et is the ethylene content by weight.

19. The multilayer film structure of claim 18, comprising a packaging film.

20. The multilayer film structure of claim 18, wherein the butene content of the terpolymer is from about 3% to about 10% by weight, such as from about 5% to about 8% by weight.

21-24. (canceled)
